(19) United States
(12) Patent Application Publication
(10) Pub. No.: US 2023/0368938 A1
(43) Pub. Date: Nov. 16, 2023

(54) GAS MIXTURE INCLUDING A FLUORINATED NITRILE FOR GAS-INSULATED SWITCHGEAR

(71) Applicant: Eaton Intelligent Power Limited, Dublin (IE)

(72) Inventors: Li Yu, Charlotte, NC (US); William E. Wilkie, II, Fletcher, NC (US); Adams Dreher Baker, Asheville, NC (US); David Glenn Woolard, Mauldin, SC (US); Daniel Garett Sims, Newberry, SC (US); Jerry Sluder Wang, Greenwood, SC (US)

(21) Appl. No.: 18/309,193

(22) Filed: Apr. 28, 2023

Related U.S. Application Data
(60) Provisional application No. 63/335,797, filed on Apr. 28, 2022.
(60) Provisional application No. 63/335,784, filed on Apr. 28, 2022.

(51) Int. Cl. H01B 3/16

(52) U.S. Cl. CPC H01B 3/16

(57) ABSTRACT

A gas mixture including at least a fluorinated nitrile, carbon dioxide and oxygen for use in electrical equipment is provided. The percentage of oxygen may be at least twice the percentage of the fluorinated nitrile. An additive gas may be present in the gas mixture. A switchgear unit having a gas-insulated compartment including a gas mixture including at least a fluorinated nitrile, carbon dioxide and oxygen is also provided. The percentage of oxygen may be at least twice the percentage of the fluorinated nitrile. An additive gas may be present in the gas mixture housed in the gas-insulated compartment.

### CROSS-REFERENCE TO RELATED APPLICATIONS

This application claims the benefit of U.S. Provisional Application No. 63/335,784 filed Apr. 28, 2022 and U.S. Provisional Application No. 63/335,797 filed Apr. 28, 2022, the contents of which are hereby incorporated herein by reference in their entireties.

### FIELD

The inventive subject matter relates to an insulating gas, and more particularly, to an insulating gas mixture used as an insulation medium in switchgear, and to electrical apparatus, and more particularly, to switchgear including the insulating gas.

### BACKGROUND

Currently, sulfur hexafluoride (SF₆) is used widely in gas-insulated switchgear (GIS). However, SF₆ gas has a relatively high global warming potential (GWP) of 23500. Therefore, its use and handling are highly regulated in many countries and legislative revisions in some countries aim to phase out the use of SF₆ in electric power equipment completely in the coming years to decades.

### SUMMARY

Some embodiments of the inventive subject matter provide a composition for use in an electrical device, the composition including a gas mixture including at least a fluorinated nitrile, carbon dioxide and oxygen.

In some embodiments, the molar percentage of oxygen is greater than 25%.

According to some embodiments, the molar percentage of oxygen is at least two times greater than the molar percentage of the fluorinated nitrile.

In some embodiments, the gas mixture also includes an additive gas.

Some embodiments of the inventive subject matter provide a switchgear unit having a gas-insulated compartment including a gas mixture including at least a fluorinated nitrile, carbon dioxide and oxygen. In some embodiments, the molar percentage of oxygen is greater than 25%.

In some embodiments, the molar percentage of oxygen in the gas mixture is greater than 25%.

According to some embodiments, the molar percentage of oxygen in the gas mixture is at least two times greater than the molar percentage of the fluorinated nitrile.

In some embodiments, the gas mixture housed in the gas-insulated compartment also includes an additive gas.

In further embodiments, the switchgear unit is a high-voltage switchgear. In some embodiments, the switchgear unit is a medium-voltage switchgear.

### BRIEF DESCRIPTION OF THE DRAWINGS

FIG. 1 illustrates a conventional switchgear unit including an SF6 tank.

FIGS. 2A-2B illustrate a switchgear unit according to some embodiments of the inventive subject matter. FIG. 2A is a perspective view of an exterior of the switch gear unit. FIG. 2B is a perspective view of an interior of the switchgear unit.

FIG. 3 is a graph depicting dielectric performance based upon oxygen concentration in a gas mixture including a fluorinated nitrile.

FIG. 4 is a flammability graph depicting the limiting oxygen concentration (LOC) at various pressures.

FIG. 5 is diagram illustrating the comparison of switchgear units including a gas mixture including a fluorinated nitrile according to some embodiments of the inventive subject matter compared to a switchgear unit including SF6.

FIG. 6 is a graph depicting the performance of switchgear units including a gas mixture including a fluorinated nitrile according to some embodiments of the inventive subject matter relative to a switchgear unit including SF6.

FIG. 7 is a diagram illustrating the comparison of switchgear units including a gas mixture including a fluorinated nitrile according to some embodiments of the inventive subject matter compared to a switchgear unit including SF6.

FIG. 8 is a graph depicting the performance of switchgear units including a gas mixture including a fluorinated nitrile according to some embodiments of the inventive subject matter relative to a switchgear unit including SF₆.

### DETAILED DESCRIPTION

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like items. It will be understood that when an item is referred to as being “connected” or “coupled” to another item, it can be directly connected or coupled to the other item or intervening items may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, items, and/or components, but do not preclude the presence or addition of one or more other features, integers, steps, operations, items, components, and/or groups thereof. Additionally, it should be noted that various embodiments of the presently disclosed subject matter may “comprise,” “consist of” or “consist essentially of” the components or constituents disclosed herein.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

As used herein and in keeping with terminology commonly used in the electrical switchgear industry, “gas-insulated” refers to insulation using a relatively high dielectric gas (e.g., a pure gas or gas mixture) that has a different composition than ambient air and thus provides enhanced insulation with respect to ambient air. The insulation gas used in a gas-insulated switchgear component according to embodiments of the inventive subject matter include alternatives to sulfur hexafluoride (SF6). It will be appreciated that the composition of such an insulation gas may be maintained, for example, by containment of the insulation gas within a sealed compartment and/or control of the gas composition using an active control system.

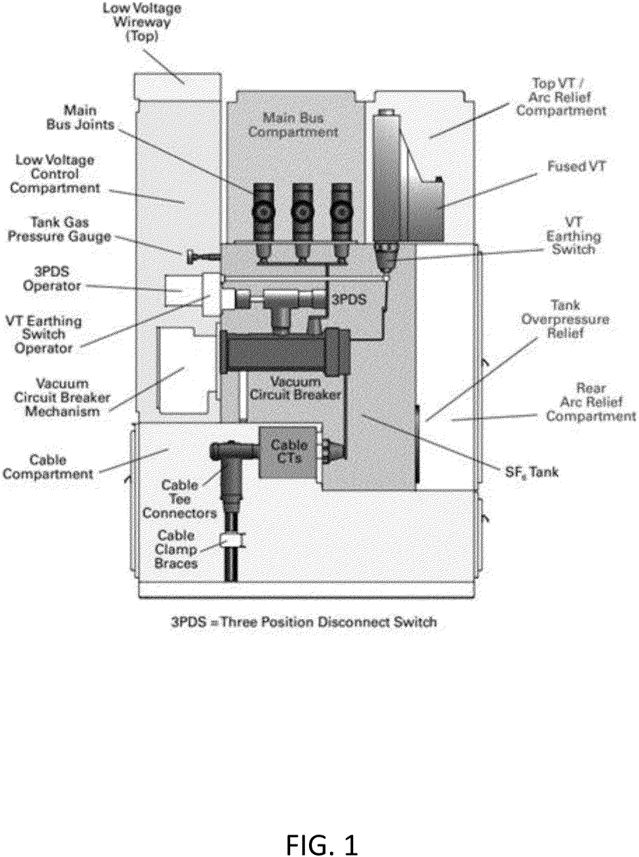

FIG. 1 illustrates a conventional switchgear unit including an SF6 tank compartment.

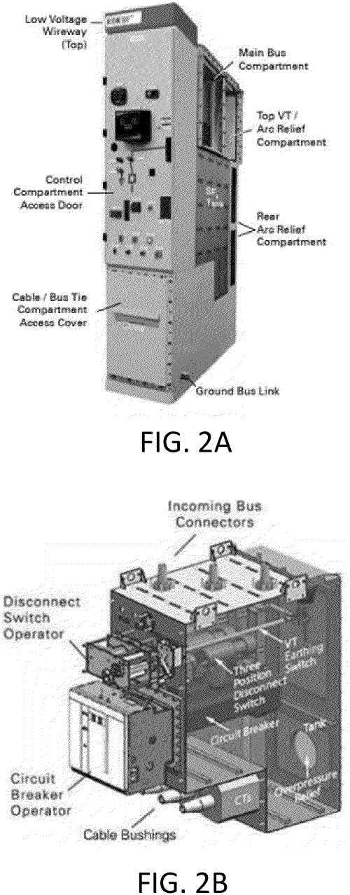

FIGS. 2A and 2B illustrate an exterior of a switch gear unit (FIG. 2A) and an interior of a switchgear unit (FIG. 2B) wherein an SF6 alternative gas mixture is utilized in a tank that houses a vacuum circuit breaker. It will be appreciated, however, that gas-insulated compartments in various embodiments may include other switchgear components, such as bus bars, disconnect switches, and the like.

According to some embodiments of the inventive subject matter, the alternative gas mixture includes at least a fluorinated nitrile, carbon dioxide and oxygen. According to some embodiments, the fluorinated nitrile includes C4FN (C4F7N, C4 nitrile, C4-PFN, C4 Perfluoronitrile).

In some embodiments, the molar percentage of oxygen is at least twice the molar percentage of the fluorinated nitrile. For example, if the fluorinated nitrile concentration is 10%, the oxygen concentration is greater than 20%. In some embodiments, the molar percentage of oxygen is less than 50%. In other embodiments, the molar percentage of oxygen is in the range of 18% to 45%, in some embodiments, 20% to 40%, and in some embodiments, 26% to 30%. In specific embodiments, the molar percentage of oxygen is greater than 25%. In yet some embodiments, the molar percentage of oxygen does not exceed 40%, 50% or 60%.

In some embodiments, the gas mixture includes 15% fluorinated nitrile, 30% oxygen and 55% carbon dioxide. In some embodiments, the gas mixture includes 10% fluorinated nitrile, 26% oxygen and 64% carbon dioxide. In some other embodiments, the gas mixture includes 20% fluorinated nitrile, 40% oxygen and 40% carbon dioxide.

According to some embodiments of the inventive subject matter, the gas mixture further includes an additive gas. The additive gas may include at least one of dry air, nitrogen and a noble gas. Table 1 includes a non-limiting example of suitable additive gases. Dry air may include primarily nitrogen with oxygen. Dry air may also include argon, carbon dioxide and/or trace elements of other gases. In some embodiments, dry air includes nitrogen and oxygen. A noble gas is one that, under standard conditions, is generally an odorless, colorless, monatomic gas with very low chemical reactivity. Noble gases may include helium, neon, argon, krypton, xenon and radon. In some embodiments, the noble gas is selected from at least one of helium, argon and neon. In still some embodiments, the molar percentage of the additive gases is in a range from 1% to 15%, and preferably, 1% to 10%. In some embodiments, the molar percentage of oxygen is 25% or less in the gas mixture comprising a fluorinated nitrile, carbon dioxide, oxygen and the additive gas. In some embodiments, the molar percentage of oxygen is greater than 25%, particularly when the gas mixture includes an additive gas.

TABLE 1

Exemplary additive gases

| | |
|---|---|
| Chemical name | Molecular formula |
| Nitrogen | N2 |
| Dry Air | N2+O2 |
| Helium | He |
| Argon | Ar |
| Neon | Ne |
| Nitrous oxide | N₂O |
| Trifluoroiodomethane | CF31 |
| Hydrofluoroolefin(HFO1234zeE) | C₃H2F4 |

According to some embodiments of the inventive subject matter, the additive gas can be used to track leakage associated with the switchgear.

The alternative gas mixture including a fluorinated nitrile, carbon dioxide and oxygen according to various embodiments of the inventive subject matter unexpectedly improves dielectric performance while also reducing toxicity. Specifically, dielectric performance can be improved and toxicity reduced while increasing the percentage of the fluorinated nitrile in the gas mixture and maintaining a concentration of oxygen that is at least twice the concentration of the fluorinated nitrile.

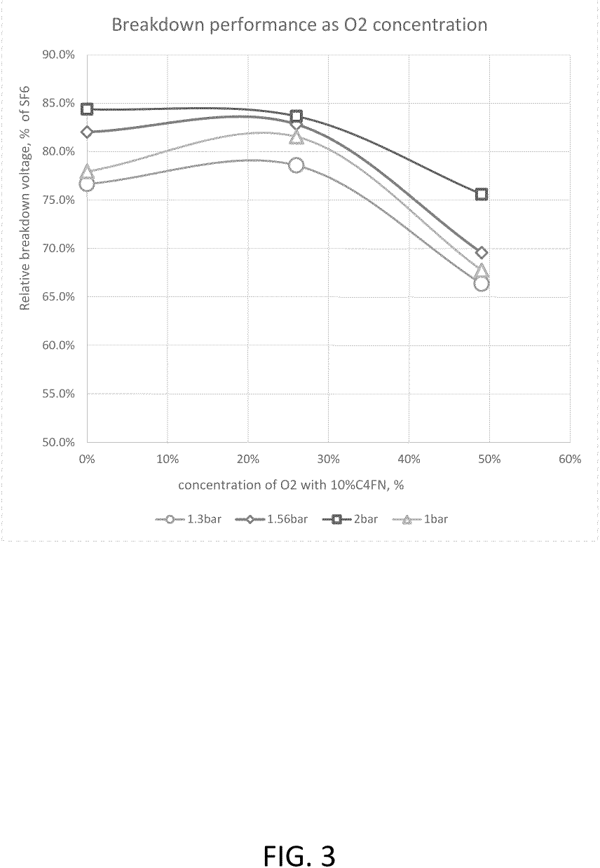

Referring to FIG. 3, under test conditions with 10% C4FN, 10 mm contact gap and between 1 and 2 bar, the dielectric strength of the alternative gas mixture does not change when the oxygen concentration is around 26% to 30%. However, if the oxygen concentration is higher, for example 49%, the dielectric strength of the gas mixture is significantly reduced. Thus, there can be a diminishing electric and switching performance as the fluorinated nitrile and oxygen percentages increase.

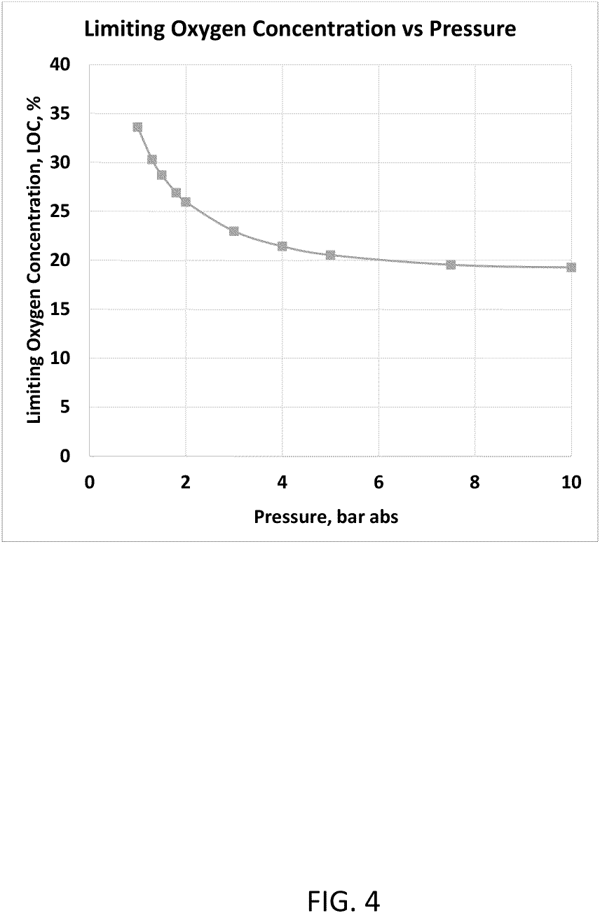

FIG. 4 demonstrates a flammability calculation wherein if the pressure is changed from 1 bar to 2 bar abs, the limiting oxygen concentration (LOC) or minimum oxygen concentration (MOC) is around 30% to 26%. There is also an upper limit for the oxygen concentration if the gas mixture is used in medium voltage gas-insulated switchgear at less than 2 bar.

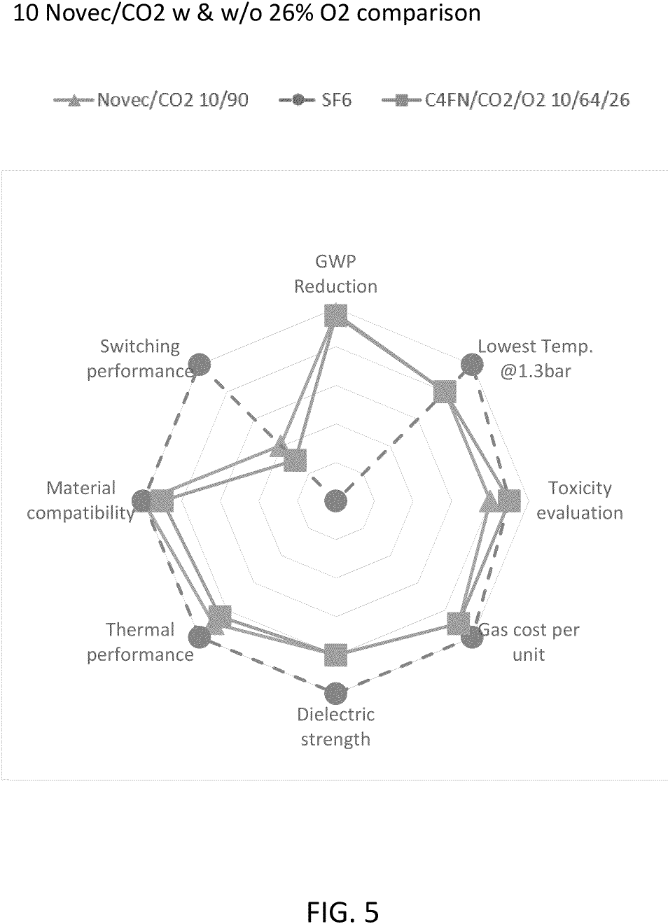

Referring to FIG. 5, a gas mixture including a fluorinated nitrile according to some embodiments of the inventive subject matter compare favorably in the performance to switchgear units including SF6. Specifically, a gas mixture including 10% C4FN, 64% carbon dioxide and 26% oxygen showed a favorable profile when evaluated and compared to (a) a gas mixture including 10% NovecTM (a proprietary methoxy-nonafluorobutane) and 90% carbon dioxide, and (b) SF6 gas in areas such as GWP reduction, temperature, toxicity, cost, dielectric properties, thermal performance, material compatibility and switching performance.

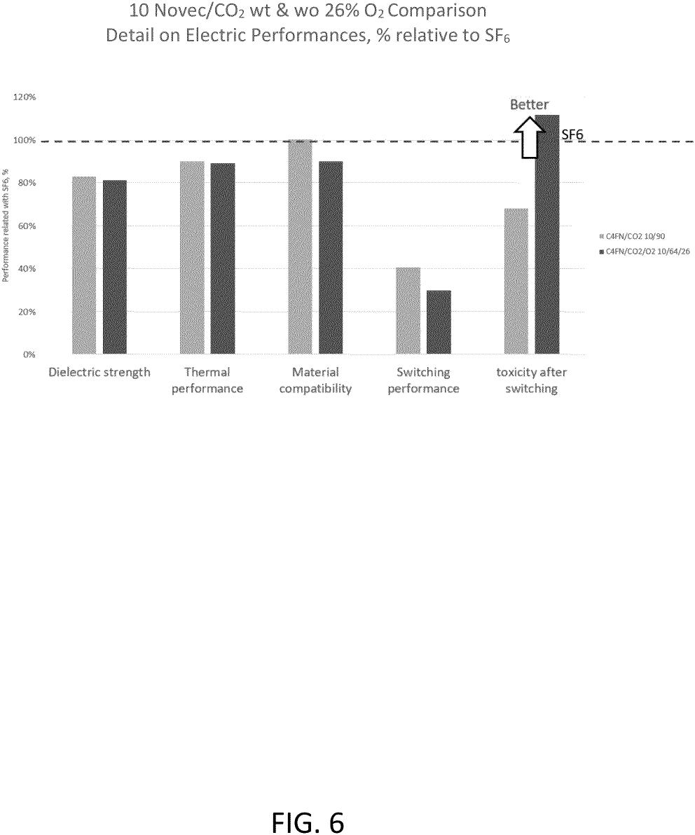

FIG. 6 demonstrates the electric performance of a 10% fluorinated nitrile with and without 26% oxygen relative to SF6 regarding dielectric strength, thermal performance, material compatibility, switching performance and toxicity after switching.

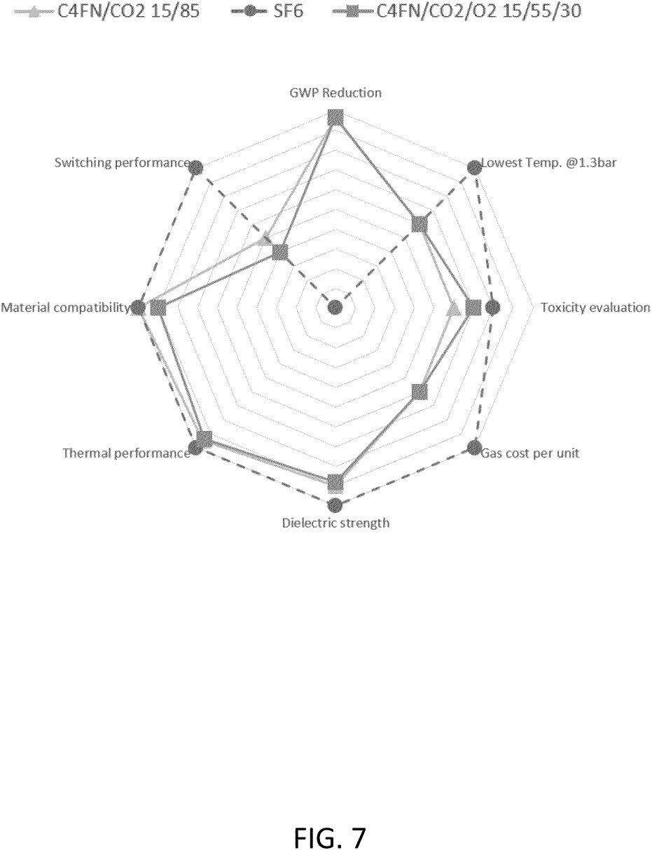

As shown in FIG. 7, a gas mixture including 15% fluorinated nitrile with and without 30% oxygen showed a favorable profile when evaluated and compared to SF6 in areas such as GWP reduction, temperature, toxicity, cost, dielectric properties, thermal performance, material compatibility and switching performance.

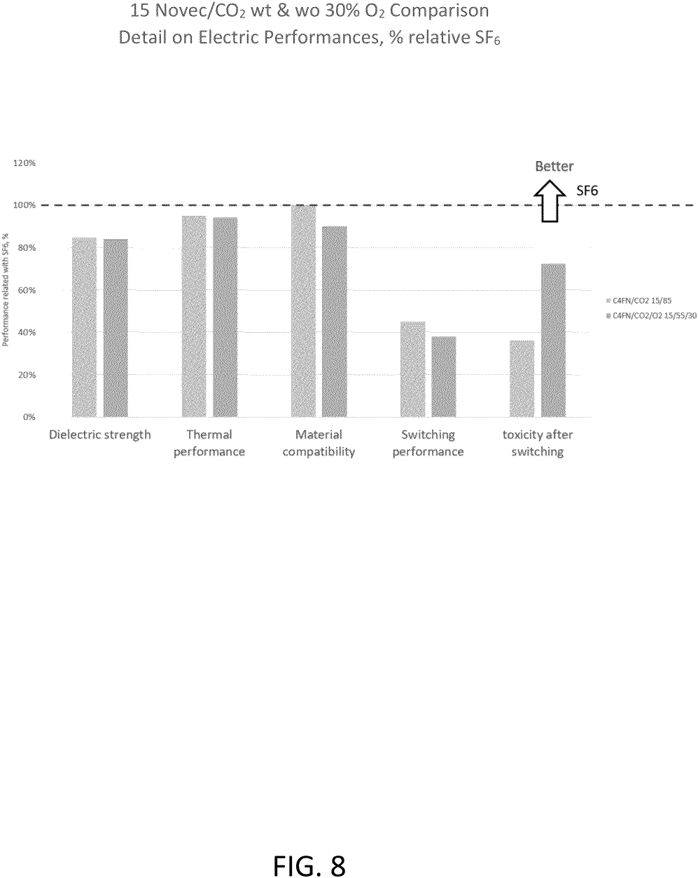

FIG. 8 demonstrates the electric performance of a 15% fluorinated nitrile with and without 30% oxygen relative to SF6 regarding dielectric strength, thermal performance, material compatibility and switching performance and toxicity after switching.

According to some embodiments of the inventive subject matter, the gas mixture including a fluorinated nitrile, carbon dioxide and oxygen is suitable for use in high-voltage switchgear. In still other embodiments, the gas mixture including a fluorinated nitrile, carbon dioxide and oxygen is suitable for use in medium-voltage switchgear. The terms “medium voltage” and “high voltage” are used in the conventionally accepted manner, i.e., the term “medium voltage” refers to a voltage that is greater than 1000 volts (V) for AC and 1500 V for DC, but does not exceed 52,000 V for AC or 75,000 V for DC, whereas the term “high voltage” refers to a voltage that is strictly greater than 52,000 V for AC and 75,000 V for DC.

In some embodiments of the inventive subject matter, the gas mixture including at least a fluorinated nitrile, carbon dioxide and oxygen provides an alternative for SF6 for electrical insulation in electrical equipment, such as gas-insulated switchgear units, and/or for extinguishing electric arcs that are likely to occur in an enclosure housing the insulating gas in the electrical equipment.

Further, devices having a compartment including the alternative gas mixture including a fluorinated nitrile, carbon dioxide and oxygen according to various embodiments of the inventive subject matter unexpectedly have improved dielectric performance while also having reduced toxicity. Specifically, dielectric performance can be improved and toxicity reduced while increasing the percentage of the fluorinated nitrile in the gas mixture and maintaining a concentration of oxygen that is at least twice the concentration of the fluorinated nitrile.

In the drawings and specification, there have been disclosed exemplary embodiments of the inventive subject matter. Although specific terms are employed, they are used in a generic and descriptive sense only and not for purposes of limitation. The following claims are provided to ensure that the present application meets all statutory requirements as a priority application in all jurisdictions and shall not be construed as limiting the scope of the inventive subject matter.

1. A composition for use in an electrical device, the composition comprising a gas mixture comprising a fluorinated nitrile, carbon dioxide and oxygen, wherein the molar percentage of oxygen is greater than 25%.

2. The composition of claim 1, wherein the molar percentage of oxygen is at least two times greater than the molar percentage of the fluorinated nitrile.

3. The composition of claim 1, wherein the fluorinated nitrile comprises C₄FN (C₄F₇N, C₄ nitrile, C₄-PFN, C₄ Perfluoronitrile).

4. The composition of claim 1, wherein the gas mixture further comprises an additive gas comprising at least one of dry air, nitrogen and a noble gas.

5. The composition of claim 1, wherein the composition is a dielectric composition.

6. The composition of claim 1, wherein the electrical device is a gas-insulated switchgear unit.

7. The composition of claim 6, wherein the switchgear unit is a high-voltage switchgear or a medium-voltage switchgear.

8. A composition for use in an electrical device, the composition comprising a gas mixture comprising a fluorinated nitrile, carbon dioxide, oxygen and a gas selected from dry air, nitrogen and/or a noble gas.

9. The composition of claim 8, wherein the gas is helium, argon and/or neon.

10. The composition of claim 9, wherein the gas is helium.

11. The composition of claim 8, wherein the composition is a dielectric composition.

12. The composition of claim 8, wherein the electrical device is a gas-insulated switchgear unit.

13. The composition of claim 12, wherein the switchgear unit is a high-voltage switchgear or a medium-voltage switchgear.

14. A switchgear unit having a gas-insulated compartment containing a gas mixture comprising a fluorinated nitrile, carbon dioxide and oxygen, wherein the molar percentage of oxygen is greater than 25%.

15. The switchgear unit of claim 14, wherein the molar percentage of oxygen is at least two times greater than the molar percentage of the fluorinated nitrile.

16. The switchgear unit of claim 14, wherein the fluorinated nitrile comprises C₄FN (C₄F₇N, C₄ nitrile, C₄-PFN, C₄ Perfluoronitrile).

17. The switchgear unit of claim 14, wherein the gas mixture further comprises an additive gas comprising at least one of dry air, nitrogen and a noble gas.

18. The switchgear unit of claim 14, wherein the switchgear unit is a high-voltage switchgear or a medium-voltage switchgear.

19. A switchgear unit having a gas-insulated compartment containing a gas mixture comprising a fluorinated nitrile, carbon dioxide and oxygen and a gas selected from dry air, nitrogen and/or a noble gas.

20. The switchgear unit of claim 19, wherein the gas is helium, argon and/or neon.
